(19) United States
(12) Patent Application Publication
(10) Pub. No.: US 2010/0074819 A1
(43) Pub. Date: Mar. 25, 2010

(54) PROCESS FOR CATALYTIC DECOMPOSITION OF NITROGEN PROTOXIDE

(76) Inventors: Alberto Cremona, Castell'Arquato (IT); Edoardo Vogna, Novara (IT)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/523,883

(22) PCT Filed: Jan. 23, 2008
(86) PCT No.: PCT/IB08/00149

§ 371 Date: Jul. 21, 2009

(30) Foreign Application Priority Data
Jan. 23, 2007 (IT) MI2007A000096

(51) Int. Cl. B01D 53/56; B01J 23/10

(52) U.S. Cl. 423/239.1; 502/303

(57) ABSTRACT

A process for removing nitrogen protoxide from gas mixtures which contain it, comprising contacting with a catalyst which contains mixed oxides of copper, manganese and rare earth metals in an amount expressed as percentage by weight of CuO, MnO and rare earth metal oxide in the lowest state of valency of 20-45% CuO, 50-60% MnO, and 5-20% rare earth metal oxide.

### TECHNICAL FIELD

The present invention relates to a process for catalytic decomposition of nitrogen protoxide (N₂O) to nitrogen and oxygen and to its use for removing protoxide from gas mixtures which contain it, in particular for removal from the emissions of nitric acid and adipic acid plants.

### BACKGROUND ART

Nitrogen protoxide is a harmful greenhouse gas, much more powerful than carbon dioxide; moreover, it takes part in the stratosphere in the reactions which lead to destruction of the ozone layer.

The main industrial sources of the generation of nitrogen protoxide are plants for producing nitric acid and adipic acid (a monomer used in the preparation of nylon 6,6 and 6,12).

Nitrogen protoxide is present in the emissions from adipic acid plants in considerable amounts: a typical composition comprises, in percentage by volume: 30% N₂O, 2% CO₂, 2.5% H₂O, 8-12% O₂, 50-150 ppm NOx.

The emissions of nitric acid plants generally contain 300-1700 ppm N₂O, 100-2000 ppm NOx, 1-4% O₂, the rest being nitrogen.

The emission of N₂O from nitric acid and adipic acid plants is predicted to grow by approximately 16% over the period 2005-2020.

Several catalysts are known which are used to decompose N₂O. The main ones are constituted by noble metals supported on metallic oxides of different kinds, zeolites substituted with transition metal ions or on which metallic oxides and anionic clays are supported, such as for example hydrotalcites constituted by mixed hydroxides with a stratified structure in which exchangeable or non-exchangeable anions of different kinds and water molecules are inserted between two layers.

All these catalysts have the drawback of not being thermally stable: the noble metals supported on metallic oxides because at high temperatures the particles of the metal tend to sinter, with consequent deactivation of the catalyst; the clays and the zeolites because their structure tends to collapse and thus loses its initial catalytic properties.

Catalysts are known (U.S. Pat. No. 5,705,136) which are constituted by oxides such as MnO, CuO, NiO and CoO supported on MgO, CaO, ZnO TiO₂, Al₂O₃—ZnO, Al₂O₃—TiO₂, and the like. Preferably, the catalysts contain CoO supported on MgO.

N₂O conversions are high.

Structures such as hydrotalcite, such as for example Cu₃Mg₅Al₂(OH)₂₀CO₃3H₂O, Mn₃Mg₅Al₂(OH)₂₀CO₃H₂O, can also be used.

It has now been found unexpectedly that the catalysts specified hereafter have a high catalytic activity in the decomposition of N₂O to nitrogen and oxygen and a satisfactory thermal stability, and are able to keep their activity unchanged for long periods of time.

The catalysts comprise mixed oxides of copper, manganese and rare earth metals, which are present in the following composition, expressed in percentage by weight of CuO, MnO and oxide of rare earth metals in which the metal is present in the lowest valency state: 50-60% MnO, 20-45% CuO, 5-20% rare earth metal oxide.

### DETAILED DESCRIPTION OF THE INVENTION

The preferred rare earth metal oxides are lanthanum and cerium oxides.

A preferred composition comprises lanthanum oxide in an amount of 8-16% by weight expressed as La₂O₃.

The mixed oxides which constitute the active components of the catalysts have the characteristic of being p-type semiconductors, in which conductivity increases exponentially with the temperature according to an Arrhenius-type rule and in which the charge vectors are constituted by electron vacancies. In these oxides, the lattice oxygen takes part in the oxidation reactions.

The mixed oxides are used on porous metallic supports such as alumina, silica-alumina, titanium dioxide, magnesium oxide. Gamma alumina, in the form of microspheroidal particles with a diameter of 30-80 μm, is the preferred support for reactions performed in particular in a fluid bed. The surface area (BET) of the catalyst supported in gamma alumina ranges generally from 80 to 150 m²/g. The oxides are preferably present in the support in an amount of 10-30% by weight.

In the fixed-bed reactions used in the removal of nitrogen protoxide from the emissions of nitric acid and adipic acid plants, it is preferred to use supports which have a definite geometric shape, such as perforated cylindrical granules or three-lobed granules provided with through holes at the lobes. The size of the granules is 3-10 mm in height and their circumference ranges from 3 to 10 mm.

The catalysts used in the process according to the present invention are disclosed in EP 1 197 259 B1, in which they are used to oxidize volatile organic substances and in which the use for decomposition of N₂O to nitrogen and oxygen is not provided or mentioned at all.

In order to prepare the catalysts, the support is first impregnated with an aqueous solution of a salt of lanthanum or cerium or other rare earth metal or mixtures thereof, followed by drying of the support and then calcining at temperatures preferably from 450 to 600° C. The support thus treated is then impregnated with a solution of a salt of copper and manganese, subsequently dried and then calcined at temperatures from 300 to 500° C.

Any salt of the metals mentioned above which is soluble in water can be used; preference is given to nitrates, formates and acetates.

The preferred impregnation method is provided in dry conditions, i.e., by using a volume of salt solution which is equal to, or smaller than, the volume of the pores of the support.

The decomposition of N₂O is performed at temperatures from 400 up to 900° C. The higher temperatures are used as the N₂O content increases. In the case of emission from nitric acid plants, the preferred temperature is from 600° to 800° C.

The spatial velocities range from 3000 to 60,000 h⁻¹. The N₂O content in the mixtures varies from ppm to percentages by volume of more than 20%. When working in the conditions indicated above, any NOx oxides that are present remain unchanged.

The following examples are provided merely by way of non-limiting illustration of the invention.

### EXAMPLES

The catalyst used in the examples had the following composition, expressed as a percentage by weight of:

La₂O₃=9.2

MnO=53.4

CuO=37.4

Preparation was performed by impregnating gamma alumina with an aqueous solution of lanthanum nitrate La(NO₃)₃.

The support was then dried at 110° C. and then calcined at 600° C. The calcined support was impregnated with an aqueous solution of manganese nitrate (Mn(NO₃)₃) and copper nitrate (Cu(NO₃)₂) and then dried at 120-200° C. and calcined at 450° C.

A volume of solution equal to 100% of the volume of the pores of the alumina was used for impregnation.

The oxides were present in the support in an amount of 26% by weight. The surface area of the catalyst (BET) was 110 m²/g and the porosity was 0.40 cm³/g.

Before the test, the catalyst was appropriately milled and screened.

The light-off activity of the catalyst, i.e., the temperature of the gas stream at which the catalyst decomposes 50% of the nitrogen protoxide that is present, and the temperature of total decomposition of the protoxide were selected as the main criteria for assessing the performance of the catalyst being considered.

The results obtained are given in the table.

TABLE

| Operating conditions | Unit | Example 1 | Example 2 | Example 3 | Example 4(a) |
|---|---|---|---|---|---|
| N₂O | % volume | 30 | 13 | 8.5 | 1200 ppmv |
| Oxygen | % volume | — | 5 | 5 | 1 |
| Helium | | remainder | remainder | remainder | remainder |
| Reaction start | ° C. | 445 | 430 | 430 | 300 |
| temperatures | | | | | |
| 50% conversion | | 503 | 520 | 520 | 500 |
| 100% conversion | | 576 | 620 | 585 | 560 |
| GHSV | h⁻¹ | 10,000 | 12,500 | 10,000 | 10,000 |
| Total flow-rate | Ncc/min | 200 | 200 | 200 | 200 |

(a)8000 ppmv of NO were present in the reaction mix.

The disclosures in Italian Patent Application no. MI2007A000096, from which this application claims priority, are incorporated herein by reference.

What is claimed is:

1-12. (canceled)

13. A process for removing nitrogen protoxide from gas mixtures which contain it, comprising contacting with a catalyst which comprises mixed oxides of copper, manganese and rare earth metals having a composition expressed as percentage by weight of CuO, MnO and transition metal oxide in the lowest state of valency: 50-60% MnO, 20-45% CuO, 5-20% rare earth metal oxide.

14. The process according to claim 13, used in the removal of nitrogen protoxide present in the emissions of plants for the production of nitric acid and adipic acid.

15. The process according to claim 13, wherein the gas mixes containing nitrogen protoxide are contacted with the catalysts at temperatures from 400 to 900° C.

16. The process according to claim 14, wherein the emissions released by the plants are made to pass over a fixed catalyst bed kept at temperatures from 600 to 700° C.

17. The process according to claim 13, wherein the catalyst comprises lanthanum oxide.

18. The process according to claim 13, wherein the catalyst is supported on a porous metallic oxide.

19. The process according to claim 18, wherein the catalyst is supported on microspheroidal gamma alumina.

20. The process according to claim 19, wherein the catalyst is supported on granules which have the shape of perforated cylinders or with one or more lobes having through holes parallel to the axis of the granule.

21. The process for preparing the catalyst according to claim 18, wherein the support is first impregnated with an aqueous solution of a salt of lanthanum or other rare earth metal, dried and then calcined at a temperature from 450 to 600° C. and subsequently impregnated with a solution of a copper and manganese salt, and then, after drying, calcined at temperatures from 300 to 500° C.

22. The use of catalysts comprising mixed oxides of copper, manganese and a rare earth metal present in the following quantities, expressed as percentage by weight of CuO, MnO and rare earth oxide, in which the metal is at the lowest state of valency: 20-45% CuO, 50-60% MnO and 5-20% rare earth metal oxide to remove nitrogen protoxide from the gas mixes which contain it.

23. The use according to claim 22, wherein the rare earth metal oxide is lanthanum oxide and/or cerium oxide.

24. The use according to claim 22 to remove nitrogen protoxide from the emissions of nitric acid and adipic acid plants.
